(19) United States
(12) Patent Application Publication
(10) Pub. No.: US 2006/0028285 A1
(43) Pub. Date: Feb. 9, 2006

(54) Method and apparatus for automatic tunnel configuration

(75) Inventors: Jeong-rok Jang, Suwon-si (KR); Soo-hong Park, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/186,759

(22) Filed: Jul. 22, 2005

(30) Foreign Application Priority Data
Jul. 26, 2004 (KR) 10-2004-0058343

(51) Int. Cl. H01P 5/12

(52) U.S. Cl. 333/1

(57) ABSTRACT

Method and apparatus for automatic tunnel configuration are provided. The method includes requesting information regarding end-points from one of the end-points of existing tunnels that connect second networks via a first network; and configuring new tunnels whose end-points are set up to have the end-points of existing tunnels and a new end-point, based on the requested information and information regarding the new end-point.

### CROSS-REFERENCE TO RELATED APPLICATION

This application claims the benefit of Korean Patent Application No. 10-2004-0058343, filed on Jul. 26, 2004, in the Korean Intellectual Property Office, the disclosure of which is incorporated herein in its entirety by reference.

### BACKGROUND OF THE INVENTION

1. Field of the Invention

The present invention relates to an apparatus and method of configuring tunnels that connect different networks via a network, and more particularly, to an apparatus and method of configuring IPv6-over-IPv4 tunnels (Internet Protocol version 6-over-Internet Protocol version 4).

2. Description of the Related Art

FIG. 1 is a configuration of a conventional tunneling system of an IPv4 (Internet Protocol version 4) network. Referring to FIG. 1, the tunneling system of the IPv4 network includes a first tunnel server 11, a second tunnel server 12, a third tunnel server 13, a first host 14, a second host 15, and a third host 16. The first tunnel server 11 has a built-in IPv4/IPv6 dual stack, and is located on the boundary between the IPv4 network and the IPv6 network in which the first host 14 is placed. The second tunnel server 12 has a built-in IPv4IPv6 dual stack, and is located on the boundary between the IPv4 network and the IPv6 (Internet Protocol version 6) network in which the second host 15 is placed. The third tunnel server 13 has a built-in IPv4/IPv6 dual stack, and is located on the boundary between the IPv4 network and the IPv6 network in which the third host 16 is placed.

A tunnel has been already configured between the first tunnel server 11 and the second tunnel server 12, and the third tunnel server 13 attempts to configure new tunnels which have the first tunnel server 11 and the second tunnel server 12 as their end-points.

To configure such new tunnels, the third tunnel server 13 needs information regarding the first tunnel server 11 and the second tunnel server 12. A network administrator enters a tunneling list for the third tunnel server 13 that includes this information. As such, the tunneling list for the third tunnel server 13 is manually created.

Also, the first tunnel server 11 or the second tunnel server 12 needs information regarding the third tunnel server 13 to configure a tunnel having the third tunnel server 13 as an end-point. The network administrator updates a tunneling list of the first or second tunnel server 11 or 12 to include this information. As such, the tunneling list of the first or second tunnel server 11 or 12 is also manually created.

Consequently, in the prior art, the network administrator needs to configure tunnels by hand. Aside from the extra work this requires, it also causes the problem that prompt tunnel configuration is not possible in the absence of the network administrator, or due to inexperienced administration, thereby leading to slow communication.

### SUMMARY OF THE INVENTION

Additional aspects and/or advantages of the invention will be set forth in part in the description which follows and, in part, will be apparent from the description, or may be learned by practice of the invention.

The present invention provides a method and an apparatus for automatic tunnel configuration by creating or updating a tunneling list without a network administrator's involvement, and also provides a recording medium, accessible by the computer, which stores a program to implement the same method.

According to an aspect of the present invention, there is provided a method of configuring tunnels, including: requesting information regarding end-points from one of the end-points of existing tunnels that connect second networks via a first network; and configuring new tunnels whose end-points are set up to have the end-points of existing tunnels and a new end-point, based on the requested information and information regarding the new end-point.

According to an aspect of the present invention, requesting the information is performed by requesting the information from the end-point that contains information of the greatest number of end-points

According to an aspect of the present invention, the information includes the addresses of the end-points on the first network, marks of the second networks where the end-points are located, and the lifetime of the tunnels.

According to an aspect of the present invention, the method further includes: searching for the end-points, wherein requesting the information is performed by requesting the information from one of the found end-points.

According to an aspect of the present invention, the first network is an IPv4 network, and the second networks are IPv6 networks.

According to an aspect of the present invention, requesting the information is performed by transmitting a DHCPREQUEST (Dynamic Host Configuration Protocol Request) message that contains a value indicating that it is a DHCP requesting message related to the end-points, and wherein configuring the new tunnels is performed based on information contained in a DHCPACK (Dynamic Host Configuration Protocol Acknowledge) message in which is recorded a value indication that it is a DHCP replying message related to the end-points.

According to another aspect of the present invention, there is provided an apparatus for configuring tunnels, including: a tunnel end-point information requesting unit that requests information regarding end-points from one of the end-points of existing tunnels that connect second networks via a first network; and a tunnel configuration unit that configures new tunnels whose end-points are set up to have the end-points of the requested information and a new end-point based on information regarding the new end-point.

According to an aspect of the present invention, the tunnel end-point information requesting unit requests the end-point that has information of the greatest number of end-points.

According to still another aspect of the present invention, there is provided a recording medium storing a program to implement a method of configuring tunnels, the method including: requesting information regarding end-points from one of the end-points of existing tunnels that connect second networks via a first network; and configuring new tunnels whose end-points are set up to have the end-points of the requested information and a new end-point based on information regarding the new end-point.

According to yet another aspect of the present invention, there is provided a method of providing tunnel end-points, including: notifying a node attempting to configure new tunnels that connect second networks via a first network that a corresponding notifying node is an end-point of an existing tunnel that connects the second networks via the first network; and providing information regarding end-points of existing tunnels to the notified node.

According to an aspect of the present invention, providing the information is performed by the notifying node if the notifying node receives a request from the notified node.

According to an aspect of the present invention, the information regarding the end-points includes the addresses of the end-points on the first network, marks of the second networks where the end-points are located, and the lifetime of the tunnels.

According to an aspect of the present invention, the method further comprises: updating the information regarding the end-points to include information regarding end-points of new tunnels, where the information is provided by the notified node.

According to an aspect of the present invention, notifying a node is performed by transmitting a DHCPOFFER (Dynamic Host Configuration Protocol Offer) message that contains a value indicating that it is a DHCP replying message related to the end-points, and wherein providing information is performed by transmitting a DHCPACK message that contains a value indicating that it is a DHCP replying message related with the end-points.

According to a further aspect of the invention, there is provided an apparatus for providing tunnel end-points, comprising: a tunnel end-point notifying unit that notifies a node that attempts to configure new tunnels connecting second networks via a first network that a corresponding notifying node is an end-point of an existing tunnel; and a tunnel end-point information providing unit that provides the node recognizing the notification (notified node) with information regarding end-points of existing tunnels.

According to an aspect of the present invention, the tunnel end-point providing unit provides the information if requested by the notified node.

According to a further aspect of the present invention, there is provided a recording medium storing a program to implement a method of providing tunnel end-points, the method including: notifying a node that attempts to configure new tunnels connecting second networks via a first network that a corresponding notifying node is an end-point of an existing tunnel connecting the second networks via the first network; and providing information regarding end-points of existing tunnels to the notified node.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of a conventional tunneling system of an IPv4 network;

FIG. 2 is a diagram of a tunneling system of an IPv4 network, according to an aspect of the present invention;

FIG. 3 is a block diagram of parts of the tunneling system of FIG. 2;

FIG. 4 shows a DHCP packet format;

FIG. 5 shows a typical DHCP message format;

FIG. 6 shows a DHCP requesting message format, according to an aspect of the present invention;

FIG. 7 shows a DHCP replying message format, according to an aspect of the present invention;

FIG. 8 is a flowchart of a method of providing information regarding end-points of tunnels, according to an aspect of the present invention; and

FIG. 9 is a flowchart of a method of configuring tunnels, according to an aspect of the present invention.

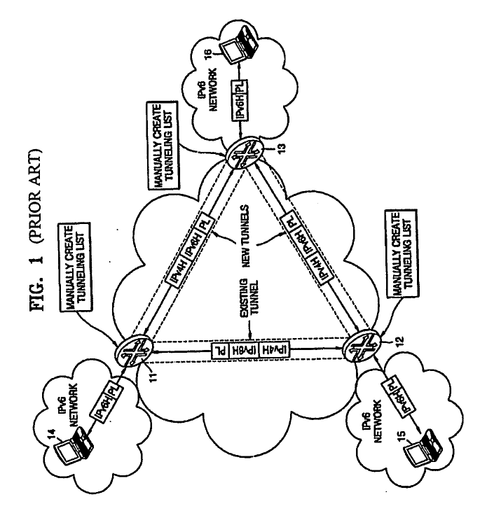

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

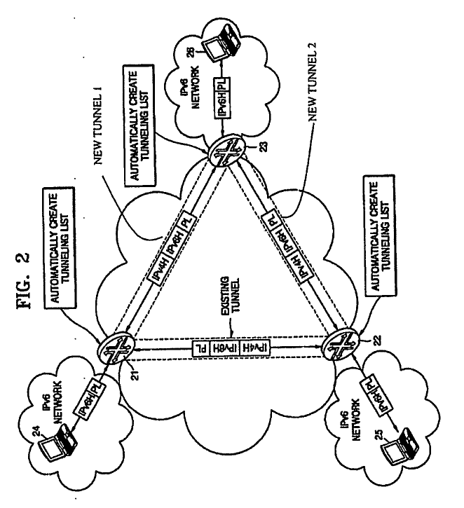

FIG. 2 is a configuration of a tunneling system of an IPv4 Network, according to an aspect of the present invention. Referring to FIG. 2, the tunneling system includes a first tunnel server 21, a second tunnel server. 22, a third tunnel server 23, a first host 24, a second host 25, and a third host 26.

The first tunnel server 21 has a built-in IPv4/IPv6 dual stack, and is located on the border between the IPv4 network and an IPv6 network in which the first host 24 is placed. The first tunnel server 21 supports dynamic host configuration protocol (DHCP) for automatic tunnel configuration. It is understood that the network may have other networks other than Ipv4 or Ipv6.

The second tunnel server 22 has a built-in IPv4 /IPv6 dual stack, and is located on the border between the IPv4 network and an IPv6 network in which the second host 25 is placed. The second tunnel server 22 also supports DHCP for automatic tunnel configuration.

The third tunnel server 23 has a built-in IPv4/IPv6 dual stack, and is located on the border between the IPv4 network and an IPv6 network in which the third host 26 is placed. The third tunnel server 23 also supports DHCP for automatic tunnel configuration.

A tunnel has already been configured between the first tunnel server 21 and the second tunnel server 22, and the third tunnel server 23 attempts to configure new tunnels which respectively have the first tunnel server 21 and the second tunnel server 22 as their (tunnel) end-points.

In order for the third tunnel server 23 to configure the new tunnels, the third tunnel server 23 needs information regarding the first tunnel server 21 and the second tunnel server 22. According to an embodiment of the present invention, the third tunnel server 23 obtains the information using DHCP without any network administrator's involvement, allowing the third tunnel server 23 to create a tunneling list automatically.

Also, in order for the first tunnel server 21 or the second tunnel server 22 to configure a tunnel having the third tunnel server 23 as an end-point, the first tunnel server 21 or the second tunnel server 22 needs information about the third tunnel server 23. According to the embodiment of the present invention, the first tunnel server 21 or the second tunnel server 22 updates its own tunneling list using DHCP without any network administrator's involvement, allowing the tunneling list of the first tunnel server 21 or the second tunnel server 22 to be automatically updated.

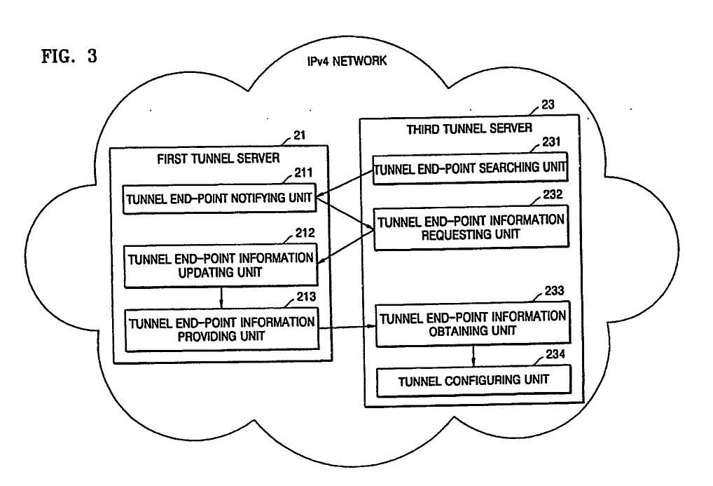

FIG. 3 is a block diagram of parts of the tunneling system of FIG. 2. Referring to FIG. 3, the first tunnel server 21 of FIG. 2 includes a tunnel end-point notifying unit 211, a tunnel end-point information updating unit 212, and a tunnel end-point information providing unit 213.

The tunnel end-point notifying unit 211 notifies a node that attempts to configure new tunnels connecting second networks via a first network that the first tunnel server is an end-point of an existing tunnel that connects second networks via the first network. In other words, the tunnel end-point notifying unit 211 notifies the third tunnel server 23 that attempts to configure new tunnels that connect IPv6 networks via the IPv4 network that the first tunnel server 21 is a tunnel server of an existing IPv6-over-IPv4 tunnel that connects IPv6 networks via the IPv4 network. Here, the tunnel end-point notifying unit 211 also notifies the third tunnel server 23 of the number of tunnel end-points, namely, tunnel servers registered in a tunneling list of the first tunnel server 21. The tunneling list is a list having information regarding tunnel end-points or tunnel servers according to an aspect of the present invention.

According to an aspect of the present invention, the tunnel end-points information includes addresses of tunnel end-points on the first network, marks of the second networks on which the tunnel end-points are located, lifetime of tunnels, etc. In other words, the tunnel end-points information includes IPv4 addresses of tunnel servers, prefixes of the IPv6 networks on which the end-points are located, lifetime of tunnels, etc., and also includes information regarding other tunnel servers not shown but possibly present in FIG. 2. As shown in FIG. 2, to configure the IPv6-over-IPv4 tunnel that connects IPv6 networks via the IPv4 network, IPv6 packets are to be encapsulated into IPv4 headers.

To encapsulate the IPv6 packets in the IPv4 headers, all the tunnel servers 21, 22, and 23 have a function to create IPv4 headers that are attributed to IPv6 packets, as well as the functions of a general router. The tunnel servers 21, 22, and 23 should know the IPv4 addresses of other tunnel servers and the lifetime of tunnels, to create such IPv4 headers. In addition, the tunnel servers 21, 22, and 23 should know the prefixes of the IPv6 networks on which the other tunnel servers are located, to route IPv6 packets to the correct IPv6 networks.

For example, when the first host 24 attempts to transmit an IPv6 packet to the second host 25, the first tunnel server 21 attributes an IPv4 header destined to the second tunnel server 22 to the IPv6 packet received from the first host 24, and thus tunnels the IPv6 packet in the format of an IPv4 packet. Here, the first tunnel server 21 should know the IPv4 address of the second tunnel server 22 and the lifetime of the IPv6-over-IPv4 tunnel.

The tunnel end-point information updating unit 212 updates information regarding the end-points of tunnels to include information regarding the end-points of new tunnels, which is presented by a tunnel server having recognized the notification from the tunnel end-point notifying unit 211. In other words, the tunnel end-point information updating unit 212 updates information regarding tunnel servers by adding the IPv4 address of the third tunnel server 23 that has recognized the notification from the tunnel end-point notifying unit 211, the lifetime of the new IPv6-over-IPv4 tunnel, and the prefix of the IPv6 network in which the third tunnel sever 23 is located.

The tunnel end-point information providing unit 213 provides information regarding the end-points of existing tunnels if requested by the third tunnel server 23 that has recognized the notification from the tunnel end-point notifying unit 211. In other words, the tunnel end-point information providing unit 213 provides a tunneling list for the third tunnel sever 23 if requested for the end-points of the existing IPv6-over-IPv4 tunnels from the third tunnel server 23 that has recognized the notification from the tunnel end-point notifying unit 211.

Referring again to FIG. 3, the third tunnel server 23 of FIG. 3 includes a tunnel end-point searching unit 231, a tunnel end-point information requesting unit 232, a tunnel end-point information obtaining unit 233, and a tunnel configuring unit 234.

The tunnel end-point searching unit 231 searches for tunnel end-points that exist on the first network. In other words, the tunnel end-point searching unit 231 searches for tunnel servers on the IPv4 network.

The tunnel end-point information requesting unit 232 requests information regarding the end-points of tunnels from the existing end-point that connects second networks via the first network and has information of the greatest number of end-points. In other words, the tunnel end-point information requesting unit 232 receives a notification of the number of tunnel servers registered in a tunneling list from each of the tunnel servers searched for by the tunnel end-point searching unit 231, and then requests information regarding tunnel servers from a tunnel server whose tunneling list has the greatest number of registered tunnels servers. The reason for requesting from the tunnel server whose tunneling list has the greatest number of registered tunnel servers is that it is possible for a tunnel server to configure new IPv6-over-IPv4 tunnels to create a more abundant tunneling list.

In the present embodiment, it is assumed that the first tunnel server 21 has the tunneling list in which the greatest number of tunnel servers are registered. There is a difference in the number of the registered tunnel servers between tunneling lists, resulting from the fact that not all the regions in the IPv4 network are guaranteed for the same reliability of communication.

The tunnel end-point information obtaining unit 233 obtains information regarding the end-points of tunnels from an end-point requested by the tunnel end-point information requesting unit 232. In other words, the tunnel end-point information obtaining unit 233 receives the tunneling list from the first tunnel server 21 requested by the tunnel end-point information requesting unit 232, and thus automatically creates the tunneling list without any administrator's involvement.

The tunnel configuring unit 234 configures new tunnels having existing tunnel end-points and new tunnel end-points based on the information regarding the end-points obtained by the tunnel end-point information obtaining unit 233 and information regarding a new end-point. In other words, the tunnel configuring unit 234 configures new IPv6-over-IPv4 tunnels having existing tunnel servers and the new tunnel server 23 as end-points based on the information regarding tunnel servers obtained by the tunnel end-point information obtaining unit 233 and information regarding the new tunnel server 23.

For example, the tunnel configuring unit 234 records the IPv4 addresses of the first tunnel server 21 and the third tunnel server 23 in address fields of IPv4 headers, sets up the lifetime of the new IPv6-over-IPv4 tunnel, and thus configures the new IPv6-over-IPv4 tunnel 1, shown in FIG. 2. In addition, the tunnel configuring unit 234 records the IPv4 addresses of the second tunnel server 22 and the third tunnel server 23 in address fields of IPv4 headers, sets up the lifetime of the new IPv6-over-IPv4 tunnel, and thus configures a new IPv6-over-IPv4 tunnel 2, shown in FIG. 2.

According to an embodiment of the present invention, DHCP, defined in Request for Comments (RFC) 1531, is employed to allow such automatic tunnel configuration based on an existing protocol, instead of introducing a new protocol to perform the automatic tunnel configuration. In particular, DHCP is employed in the embodiment because it never demands any manual configuration, and is able to pass through routers, such as proxy servers beyond subnets, so that the automatic tunnel configuration intended by the present invention is easily accomplished.

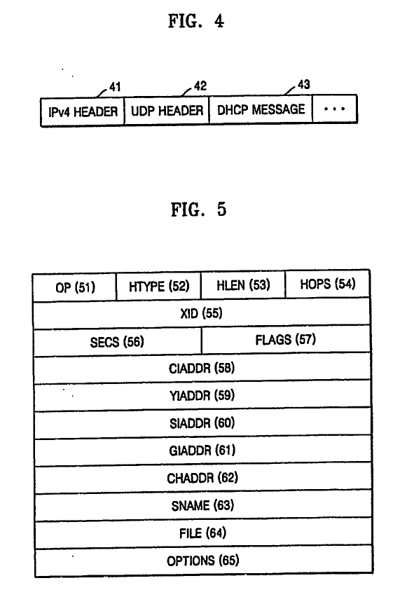

FIG. 4 illustrates a DHCP packet format. Referring to FIG. 4, the DHCP packet includes an IPv4 header 41, a User Datagram Protocol(UDP) header 42, and a DHCP message 43. DHCP is based on a Bootstrap Protocol (BOOTP). The DHCP message 43 is recorded in a UDP data field. Thus, there is no reliability in transmitting the DHCP message, which can be one reason for the difference in the number of tunnel servers registered in the tunneling lists of the tunnel servers.

FIG. 5 illustrates a common DHCP message format. Referring to FIG. 5, the common DHCP message includes an op field 51, an htype field 52, a hlen field 53, a hops field 54, a xid filed 55, a secs field 56, a flags field 57, a ciaddr filed 58, a yiaddr field 59, a siaddr field 60, a giaddr field 61, a chaddr field 62, a sname field 63, a file field 64, and an options field 65.

DHCP messages can be generally classified as either DHCP requesting messages or DHCP replying messages. A DHCP requesting message includes DHCPDISCOVER, DHCPREQUEST, etc. A DHCP replying message includes DHCPOFFER, DHCPACK, etc.

The op field 51 has an OP code that represents the type of DHCP message. The htype field 52 has a value that represents the type of hardware address of a client. The hlen field 53 has a value that represents the length of the hardware address of the client. The hops field 54 has a value that represents how many routers the DHCP message has passed through.

The xid field 55 has a value for identifying the client. The value may be the same value as the hardware address recorded in the chaddr field 62. The secs field 56 has a value indicating the time elapsed since the client's booting. The flags field 57 has a value that represents a transmission method, such as broadcasting, unicasting, and multicasting.

The ciaddr field 58 has the IP address of the client. The IP address of the client can be recorded in the ciaddr field 58 only if the client knows its own IP address, and otherwise, 0.0.0.0 is recorded in the ciaddr field 58. The yiaddr field 59 has the IP address of the client, as assigned by a server. The IP address can be recorded in the yiaddr field 59 only if 0.0.0.0 is recorded in the ciaddr filed 58.

The sia field 60 has the IP address of the server. The giaddr field 61 has the IP address of a gateway if the DHCP message passes through a gateway. The chaddr field 62 has a hardware address of the client. The sname field 63 has a host name of the server. The file field 64 has a boot file name. The options field 65 has predefined option parameters.

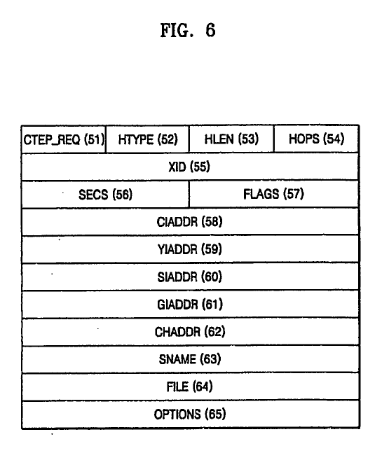

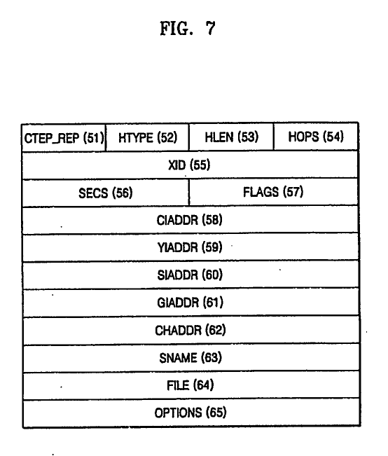

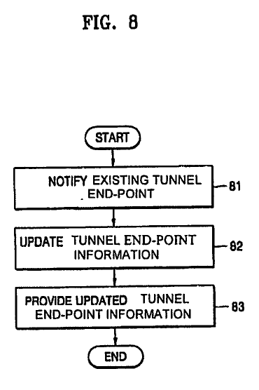

FIG. 6 illustrates the DHCP requesting message format, according to an embodiment of the present invention. Referring to FIG. 6, the DHCP requesting message has the same format as the DHCP message shown in FIG. 5. However, the DHCP requesting message fills the op field 51 with a value indicating that the message is a tunnel end-point-related DHCP requesting message, that is, a configured tunnel end-point_request (CTEP_REQ) message, instead of a value indicating that it is a DHCP requesting message.

FIG. 7 illustrates the DHCP replying message format, according to an embodiment of the present invention. Referring to FIG. 7, the DHCP replying message has the same format as the DHCP message shown in FIG. 5. However, the DHCP replying message fills the op field 51 with a value indicating that the message is a tunnel end-point-related DHCP replying message, that is, a configured tunnel end-point_reply (CTEP_REP) message, instead of a value indicating that it is a DHCP replying message.

The tunnel end-point searching unit 231 (FIG. 3) broadcasts the DHCPDISCOVER message where the end-point-related DHCP requesting message is included, which conforms to the DHCP requesting message format shown in FIG. 6, over the IPv4 network, to search for tunnel servers on the IPv4 network. However, such a broadcast from the tunnel end-point searching unit 231 is only performed within a sub-net where the third tunnel server 23 is located, since the broadcast is at the link layer level. In other words, the DHCPDISCOVER message broadcast by the tunnel end-point searching unit 231 cannot go through routers, which may be one reason for the differing numbers of tunnel servers registered in tunneling lists of the tunnel servers.

The tunnel end-point notifying unit 211 (FIG. 3) sends the DHCPOFFER message where the end-point-related DHCP replying message is included, which conforms to the DHCP replying message format shown in FIG. 7, to the third tunnel server 23, to notify the third tunnel server 23 that the first tunnel server 21 is a tunnel server of the existing IPv6-over-IPv4 tunnel, if the tunnel end-point notifying unit 211 receives the DHCPDISCOVER message broadcast by the tunnel end-point searching unit 231. Here, in the options field 65 of the DHCPOFFER message, the number of tunnel servers registered in the tunneling list is included as well.

The tunnel end-point information requesting unit 232 (FIG. 3) broadcasts the DHCPREQUEST message where the end-point-related DHCP requesting message is included, which conforms to the DHCP requesting message format shown in FIG. 6, over the IPv4 network, to request information regarding tunnel servers from the tunnel server of the existing IPv6-over-IPv4 tunnel which has the greatest number of tunnel servers registered in its tunneling list, if the tunnel end-point information requesting unit 232 receives the DHCPOFFER message transmitted by the tunnel end-point notifying unit 211. In other words, the tunnel end-point information requesting unit 232 transmits the DHCPREQUEST message to a tunnel server whose options field 65 of the DHCPOFFER message has the greatest number of tunnel servers. Here, the options field 65 of the DHCPOFFER message also includes information regarding a new tunnel server, i.e., the IPv4 address of the third tunnel server, the lifetime of a new IPv6-oer-IPv4 tunnel, and the prefix of the IPv6 network where the third tunnel server 23 is located. Since the DHCPREQUEST message is broadcasted, all the tunnel servers within a sub-net are provided with the information regarding the third tunnel server 23.

The tunnel end-point information updating unit 212 (FIG. 3) records the IPv4 address of the third tunnel server 23, the lifetime of the new IPv6-over-IPv4 tunnel, and the prefix of the IPv6 network where the third tunnel server is located, which are registered in the options field 65 of the DHCPREQUEST message, as new entries of the tunneling list, to add more information regarding the third tunnel server, if the tunnel end-point information updating unit 212 receives the DHCPREQUEST message broadcast by the tunnel end-point information requesting unit 232.

The tunnel end-point information providing unit 213 (FIG. 3) sends the DHCPACK message where the value indicating the message is the tunnel end-point-related DHCP replying message, which conforms to the DHCP replying message format shown in FIG. 7, to the third tunnel server 23, to present the third tunnel server 23 with the tunneling list, when the tunnel end-point information providing unit 213 receives the DHCPREQUEST message broadcast by the tunnel end-point information requesting unit 232. Here, the options field of the DHCPACK message contains the tunneling list.

The tunnel end-point information obtaining unit 233 (FIG. 3) extracts the tunneling list from the options field 64 of the DHCPACK to automatically form the tunneling list without a network administrator's involvement, if the tunnel end-point information obtaining unit 233 receives the DHCPACK message transmitted by the tunnel end-point information providing unit 213.

The tunnel configuring unit 234 (FIG. 3) configures new Ipv6-over-IPv4 tunnels (New Tunnel 1, New Tunnel 2) which have the existing tunnel servers and the new tunnel server 23 as end-points, based on the tunneling list extracted by the tunnel end-point information obtaining unit 233 from the options field 65 of the DHCPACK message.

FIG. 8 is a flowchart of the method of providing tunnel end-point information, according to an embodiment of the present invention. Referring to FIG. 8, the method includes operations which are processed in time-series analysis by the first tunnel server 21 of FIG. 3. All the operations performed by the first tunnel server 21, which are described above in connection with FIG. 3, can be applicable to this method, even though not all of them are shown in the flowchart of FIG. 8.

In operation 81, the first tunnel server 21 notifies a node attempting to configure new tunnels that connect second networks via the first network, that the first tunnel server 21 is an end-point of the existing tunnel that connects second networks via the first network. In other words, if the first tunnel server 21 receives the DHCPDISCOVER message broadcast from the third tunnel server 23 that attempts to configure new IPv6-over-IPv4 tunnels, the first tunnel server 21 transmits to the third tunnel server 23 the DHCPOFFER message containing a value indicating that it is a DHCP replying message related to tunnel end-points, to notify that the first tunnel server 21 is a tunnel server of the existing IPv6-over-IPv4 tunnel. Here, the options field 65 of the DHCPOFFER message also contains the number of tunnel servers registered in the tunneling list.

In operation 82, the first tunnel server 21 updates information regarding end-points of tunnels to include end-points of new tunnels provided by a tunnel end-point which has recognized the notification in operation 81. In other words, if the first tunnel server 21 receives the DHCPREQUEST message broadcast from the third tunnel server 23, the first tunnel server 21 adds information regarding the third tunnel server 23 to its tunneling list by recording new entries of the IPv4 address of the third tunnel server 23 recorded on the options field 65 of the DCHPREQUEST message, the lifetime of the new IPv6-over-IPv4 tunnel, and the prefix of the IPv6 network where the third tunnel server 23 is located.

In operation 83, the first tunnel server 21 provides information regarding end-points of existing tunnels to the third tunnel server 23, if requested by the third tunnel server 23 that has recognized the notification in operation 81. In other words, if the first tunnel server 21 receives the DHCPREQUEST message broadcast by the tunnel end-point information requesting unit 232, the first tunnel server 21 transmits to the third tunnel server 23 the DHCPACK message indicating that it is a DHCP replying message related to tunnel end-points, to present the third tunnel server 23 with the tunneling list. Here, the options field 65 of the DHCPACK message contains the tunneling list.

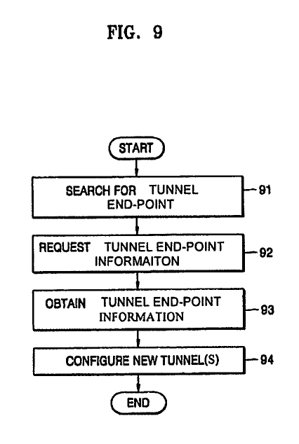

FIG. 9 is a flowchart of a method of configuring tunnels, according to an embodiment of the present invention. Referring to FIG. 9, the method includes operations which are processed in time-series analysis by the third tunnel server 23 of FIG. 3. All the operations performed by the third tunnel server 23, which are described above in connection with FIG. 3, can be applicable to this method, even though not all of them are shown in the flowchart of FIG. 9.

In operation 91, the third tunnel server 23 searches for end-points of tunnels that exist in the first network. In other words, the third tunnel server 23 broadcasts the DHCPDISCOVER message over the IPv4 network, and the DHCPDISCOVER contains a value indicating that the message is a DHCP requesting message related to tunnel end-points over the IPv4 network, to search for tunnel servers that exist in the IPv4 network.

In operation 92, the third tunnel server 23 requests information regarding tunnel end-points from one of the end-points of the existing tunnels that connect second networks via the first network. Here, the tunnel end-point requesting unit 232 requests the information from the found end-point which has information of the greatest number of tunnel end-points. In other words, if the third tunnel server 23 receives the DHCPOFFER message transmitted by the first tunnel server 21, the third tunnel server 23 broadcasts the DHCPREQUEST message over the IPv4 network, the DHCPREQUEST message containing a value that indicating that the message is a DHCP requesting message related with tunnel-endpoints, to request information regarding tunnel servers from the tunnel server of an existing IPv6-over-IPv4 tunnel which has a tunneling list having information of the greatest number of registered tunnel servers.

In operation 93, the third tunnel server 23 obtains information regarding the tunnel end-points by receiving the information from the tunnel end-point requested in operation 92. In other words, the third tunnel server 23 receives the DHCPACK message transmitted by the first tunnel server 21, and then extracts a tunneling list recorded in the options field 65 of the DHCPACK, to automatically create its own tunneling list without any administrator's involvement.

In operation 94, the third tunnel server 23 configures new tunnels which share end-points with existing tunnels and also have new tunnel end-points, based on the information regarding the existing tunnel end-points and the new tunnel end-point. In other words, the third tunnel server 23 configures new IPv6-over-IPv4 tunnels which have the existing tunnel servers and the new tunnel server 23 as their end-points, based on the tunneling list extracted in operation 92 from the options field 64 of the DHCPACK message.

It is possible for the embodiments described above according to an aspect of the present invention to be implemented as a computer program. Codes and code segments constituting the computer program may readily be inferred by those skilled in the art. The computer programs may be recorded on computer-readable media in order to be read and executed by computers. Such computer-readable media include all kinds of storage devices, such as magnetic storage devices, optical data storage devices, etc. The computer-readable media also include everything that is realized in the form of carrier waves, e.g., an Internet transmission.

According to an aspect of the present invention, as described above, information regarding tunnel end-points is obtained using DHCP, thereby allowing a tunnel server to automatically create a tunneling list and configure new tunnels, without any network administrator's involvement. Also, using DHCP, the tunneling list can be automatically updated to include information regarding new tunnel end-points, without a network administrator's involvement.

As such, according to the present invention, automatic tunnel configuration is achieved without help by a network administrator, thereby easing network administration work load and trouble of manually configuring tunnels, and enabling fast communication without any human involvement.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of configuring tunnels comprising:
requesting tunnel end-point information and
configuring a new tunnel whose end-point is set up to have the tunnel end-point and a new tunnel end-point.

2. The method of claim 1, wherein requesting the tunnel end-point information requesting the tunnel end-point information from the tunnel end-point that contains the greatest number of tunnel end-points information.

3. The method of claim 1, wherein the tunnel end-point information comprises the addresses of the end-points on a first network.

4. The method of claim 3, wherein the tunnel end-point information further comprises a mark of a second network.

5. The method of claim 4, wherein the tunnel end-point information further comprises a lifetime of a tunnel.

6. The method of claim 1, further comprising:
searching for the end-point(s),
wherein requesting the tunnel end-point information requesting the tunnel end-point information from one of the found end-point(s).

7. The method of claim 1 wherein the tunnels further comprises a first network, wherein the first network is an IPv4 network.

8. The method of claim 1, wherein requesting the tunnel end-point information transmitting a dynamic host configuration protocol request (DHCPREQUEST) message that contains a value indicating that it is a DHCP (dynamic host configuration protocol) requesting message related to the end-point(s), and wherein configuring the new tunnel(s) based on information contained in a dynamic host configuration protocol acknowledge (DHCPACK) message in which is recorded a value indication that it is a DHCP replying message related to the end-points.

9. An apparatus for configuring tunnels, comprising:
a tunnel end-point information requesting unit that requests end-points information from one of the end-points of tunnels that connect a second network via a first network; and
a tunnel configuration unit that configures a new tunnel whose end-point is set up to have the end-points of the requested information and a new end-point based on the end-point information.

10. The apparatus of claim 9, wherein the tunnel end-point information requesting unit requests the end-point that has information of the greatest number of end-points.

11. A computer-readable recording medium storing a program to cause a computer to execute the procedures of:
requesting end-point information from one of the end-points of tunnels that connect a second network via a first network; and
configuring new tunnels whose end-points are set up to have the end-points of the requested information and a new end-point based on the new end-point information.

12. A method of providing tunnel end-point information, comprising:
notifying a node attempting to configure a new tunnel that connects a second network via a first network that a corresponding notifying node is a tunnel end-point that connects the second network via the first network; and
providing the tunnel end-point information to the notified node.

13. The method of claim 12, wherein providing the tunnel end-point information is performed by the notifying node if the notifying node receives a request from the notified node.

14. The method of claim 12, wherein the end-point information includes the address of the end-point on the first network.

15. The method of claim 12, further comprising:
updating the end-point information to include new tunnel end-point information, where the information is provided by the notified node.

16. The method of claim 12, wherein the first network is an IPv4 network.

17. The method of claim 12, wherein notifying a node is performed by transmitting a DHCPOFFER message that contains a value indicating that it is a DHCP replying message related to the end-points, and wherein providing information by transmitting a DHCPACK message that contains a value indicating that it is a DHCP replying message related with the end-point(s).

18. An apparatus for providing tunnel end-points, comprising:
a tunnel end-point notifying unit that notifies a node that attempts to configure a new tunnel connecting a second network via a first network that a corresponding notifying node is a tunnel end-point; and
a tunnel end-point information providing unit that provides the node recognizing the notification (notified node) with tunnel end-point information.

19. The apparatus of claim 18, wherein the tunnel end-point providing unit provides the information if requested by the notified node.

20. A computer-readable recording medium storing a program to cause a computer to execute the procedures of:
notifying a node that attempts to configure new tunnels connecting a second network via a first network that a corresponding notifying node is a tunnel end-point connecting the second network via the first network; and
providing tunnel end-point information to the notified node.
